(19) United States
(12) Patent Application Publication
(10) Pub. No.: US 2008/0038080 A1
(43) Pub. Date: Feb. 14, 2008

(54) BOLT EXTENSION SHEATH

(76) Inventors: Mark Viklund, New Milford, CT (US); Kevin W. Harris, Middlebury, CT (US)

Correspondence Address: NOVAK DRUCE + QUIGG LLP, 1300 EYE STREET NW, SUITE 1000 WEST TOWER, WASHINGTON, DC, 20005, US

(21) Appl. No.: 11/835,478

(22) Filed: Aug. 8, 2007

Related U.S. Application Data
(60) Provisional application No. 60/821,774, filed on Aug. 8, 2006.

(51) Int. Cl. F16B 39/28; F16B 37/04

(52) U.S. Cl. 411/101; 411/132; 411/134

(57) ABSTRACT

An article for retaining nuts used for secure attachment of an object to a supporting structure. The article includes a connector extending between a first housing and a second housing. The first housing includes a first nut retainer for a nut used to secure a first bolt passing through the supporting structure for attachment of the object to the supporting structure and the second housing includes a second nut retainer for a nut used to secure a second bolt passing through the supporting structure for attachment of the object to the supporting structure.

### CROSS-REFERENCE TO RELATED APPLICATIONS

The present application is based on and claims priority from provisional application 60/821,774 filed Aug. 8, 2006, the entire contents of which are incorporated by reference.

### TECHNICAL FIELD

The presently disclosed solution relates generally to means for securing load carriers to vehicles. More specifically, the invention relates to an article for affecting and assuring secure attachment of a load carrier foot base to a substantially rigid pickup truck bed cover.

### BACKGROUND

Roof racks are well known arrangements located atop many passenger vehicles and which are configured to support loads of many types. These load carriers exist in different forms including racks for directly supporting sport equipment articles, such as bicycles, snow skis and the like. Other load carriers take the form of more general cargo carriers including boxes and soft-sided car-top carriers.

It is typical for the roof of passenger vehicles to be adapted with tracks or similar assemblies that serve as points for interconnection of rack supports. In a most familiar configuration, pairs of “feet” are coupled to tracks at lateral sides of the vehicle with a transverse (with respect to the vehicle) load or cross bar suspended therebetween. These load bars primarily provide elongate locations upon which load supports can be attached. For instance, a pair of load bars might be utilized to support a bicycle carrier system.

The size or area of the roof of passenger vehicles is generally sufficient to accommodate at least two reasonably spaced load bars so that a user can attach most load systems that they desire. This, however, is not true when the cab of a pickup truck is considered. The front-to-back dimension of the top of the cab is not sufficient to allow for proper or necessary spacing between front and back load carrier bars. As a result, top-mounted load carrier systems have largely been ignored where pickup trucks are concerned, especially in the non-commercial segments.

It has however been recognized that many pickup truck beds are today often provided with caps or covers, often constructed of at least semi-rigid material, such as fiberglass. These caps typically cover the entire bed of the pickup truck giving rise to a large area highly suited for receiving loads of the nature described above, if only a suitable means for affixing load carriers were available.

Problems that must be considered, however, include the fact that such fiberglass covers do not have the local fortitude of steel plate passenger vehicle roof covers, and allowances must be made to either assure that only small loads will be transported or that some form of local fortification is provided. This is particularly true where tapped connections into the fiberglass panel of the pickup truck cover would be advantageous, but under tension, a threaded connection into such a fiberglass cap is too weak for supporting any meaningful load carrying capacity.

In summary, pickup truck bed caps of the nature described provide an attractive location for mounting load carriers but the problems explained above must be first addressed via new solutions such as that which is described in greater detail hereinbelow.

### DISCLOSURE OF THE INVENTION

The present invention in its several disclosed embodiments addresses the structural issues described above with respect to anchoring load supports on pickup truck bed cap-covers of the type(s) described above. In order to provide the required local fortification at the point of connection of the load carrier support assembly to the cap, an arrangement is utilized that provides two abutting faces located on either side of the wall panel formed by the bed cover and which are drawn together to “sandwich” a local area of the panel therebetween. In this manner, a sufficient surface area is engaged for distribution of forces (pulling and pushing) imposed on the cap-cover during normal vehicle maneuvering with a load installed.

The constricting arrangement for drawing the two sandwiching surfaces together advantageously utilizes a nut-and-bolt assembly. As disclosed, a nut retainer assembly is located under the cap-cover, inside the enclosure formed by the bed of the truck and the cap. Bolts are threaded through apertures in a foot support base that is located atop the cap-cover. The bottom of the base is provided with a surface configured for a substantial conformance fit with the top surface of the cover where the base is to be positioned. The bolt is then rotated into the nut (which is fixed against rotary motion as will be detailed below) thereby drawing the nut retainer and base together with the cap-cover sandwiched therebetween. Rack feet, cross-bars and associated load carrier assemblage is then interconnected on the anchored base thereby establishing a fortified, cap-cover mounted load carrier on the pickup truck.

In a preferred embodiment, the base is provided with two through bolts and an associated nut retainers for each bolt which provides two points of interconnection between the base and the cap-cover. In this manner, the established two-point connection prevents rotation of the base relative to the cover, and which could otherwise potentially occur with only one through bolt were used.

In an exemplary embodiment, the foot support base remains with the truck cap even when no other rack portion is attached.

Connective structure incorporated into the foot support base facilitates engagement of a supporting foot with the base to provide a substantially rigid column, extending outwardly of the pickup truck bed cap, for connection to a load carrier optionally in the form of an equipment rack that comprises struts engaging a plurality of support feet. The rack forms a frame over the truck cap to conveniently accommodate various types of equipment, commonly sports equipment, usually held to the rack by flexible ties or other suitable retaining devices.

Without suitable precaution to the contrary, the installation of the foot support base to the cap-cover using the described through-bolt technique leaves exposed bolt ends projecting downwardly inside the enclosed truck bed. Projecting bolt ends potentially represent a hazard with which cargo and passengers can come contact resulting in damage or injury. For this reason, an article according to the present invention includes housings each having a recess to shield the bolt tips to prevent physical damage to passengers seated near the nut-retaining bracket disposed inside the vehicle's roof. Housings according to the present invention include retention of securing nuts and shielding structure to mitigate property damage and potential injury to passengers. Suitable shielding structures have curved surfaces, free from sharp edges that might cause such damage or injury.

One embodiment according to the present invention uses a pair of housings to ensure twist-free securement of the base which is bolted through at opposing openings formed therein. The need to secure the base in a twist-free condition will be appreciated by considering that the object, in the form of a foot support base, must retain a prescribed orientation to facilitate attachment of a load carrier using several supporting feet connected to foot support bases.

Since it is important to use more than one bolt to prevent rotation or twisting motion, the foot support base has an elongate structure that has guide holes at opposing ends. The distance between the guide hole centers is the same as the distance between the centers of openings in the supporting structure and the distance of separation of receiving nuts held in nut retainers according to the present invention. Alignment of the guide holes, openings and receiving nuts allows insertion of bolts through the elongate base placed against the outer surface of the supporting structure. The bolts pass through the openings in the supporting structure to engage nuts in each of a number of nut retainers placed adjacent to the inner surface of the supporting structure. Rotation of the bolts draws the nuts and nut retainers into contact with the inner surface of the supporting structure. Application of sufficient rotational force produces a tight connection of the foot support base to the supporting structure.

An article configured according to the present invention, also referred to herein as a nut-retaining bracket, has a desirable form when it comprises a pair of housings joined together by an intervening bar or handle that gives the nut-retaining bracket useful additional functionality that will be explained further below. Each housing includes a single nut retainer. Correct selection of the length of the bar or handle provides separation of the receiving nuts corresponding to the distance between the centers of the guide holes.

The bar or handle of the nut-retaining bracket may be held by an installer to facilitate alignment of the receiving nuts with the openings in the supporting structure during installation of the elongate foot support base. Bolts passing through guide holes and openings engage receiving nuts positioned in nut retainers at each end of the bar or handle of the nut-retaining bracket. After tightening the nut and bolt connections the portion of the bolt extending beneath each nut remains within the housing that has a substantially spherical domed or bowl shape. The spherical shaped housing reduces the potential for property damage and passenger injury.

When fully installed, the nut-retaining bracket according to the present invention provides a cap-cover mounted handle that may be grasped as a handle to the cap-cover or may function as a rod or bridge for securing other cargo, e.g. straps or hooks or coat hangers and the like to the cover inside the enclosed truck bed.

More particularly, the present invention provides an article for retaining nuts used for secure attachment of an object to a supporting structure. The article comprises at least one housing including at least a nut retainer for a nut used to secure a bolt passing through the supporting structure for attachment of the object to the supporting structure.

An article according to the present invention has a desirable form for retaining nuts used for secure attachment of an object to a supporting structure when the article comprises a connector extending between at least a first housing and at least a second housing. The first housing includes a first nut retainer for a nut used to secure at least a first bolt passing through the supporting structure for attachment of the object to the supporting structure. The second housing includes a second nut retainer for a nut used to secure at least a second bolt passing through the supporting structure for attachment of the object to the supporting structure.

In one embodiment of an article according to the present invention, the first housing has a first recess containing the first nut retainer and the second housing has a second recess containing the second nut retainer. Also, the supporting structure has an outer surface and an inner surface. Upon attachment of the object to the supporting structure, the object lies adjacent to the outer surface and the article abuts the inner surface of the support structure.

The present invention includes an assembly for mounting a load carrier on a supporting structure. The assembly comprises a supporting foot coupled to a foot support base abutting the supporting structure that has an inner surface and an outer surface against which the foot support base is secured using at least a first bolt passing through a first opening in the supporting structure to engage at least one receiving nut held in at least a first nut retainer of a nut-retaining bracket that includes at least a first housing in contact with the inside of the supporting structure.

A process for secure attachment of an object to a supporting structure using an article for retaining nuts comprises providing the supporting structure that has an outer side and an inner side and further has at least one opening therethrough. The process requires positioning the object on the outer side of the supporting structure. Placement of the article, having at least one housing, adjacent to the inner side, positions the at least one housing that includes at least a nut retainer for a nut to receive a bolt passing through the opening in suitable fashion to engage the object on the outer side of the supporting structure and the nut in the at least a nut retainer. Initiation of relative rotation between the bolt and the nut draws the nut retainer towards the inner side until the at least one housing makes contact with the inner side sufficient for secure attachment of the object to the supporting structure.

The beneficial effects described above apply generally to the exemplary devices and mechanisms disclosed herein of the article comprising at least a nut retainer. The specific structures through which these benefits are delivered will be described in detail hereinbelow.

### BRIEF DESCRIPTION OF THE DRAWINGS

The invention will now be described in greater detail in the following way of example only and with reference to the attached drawings, in which:

FIG. 1 is a side elevation illustrating a housing containing a nut retainer according to the present invention.

FIG. 2 provides a cross-section of a housing according to the present invention.

FIG. 3 is a side elevation illustrating a nut-retaining bracket according to the present invention.

FIG. 4 provides a cross-section through line 4-4 of FIG. 3 according to the present invention.

FIG. 5 provides a cross-section through line 5-5 of FIG. 3 according to the present invention.

FIG. 6 is a perspective view illustrating channels into nut retainers according to the present invention for insertion of receiving nuts.

FIG. 7 is a cross sectional view illustrating a supporting foot for a load carrier attached to a foot support base mounted to a supporting structure using a nut-retaining bracket according to the present invention.

FIG. 8 is a perspective view of a pickup truck with a bed cap-cover.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

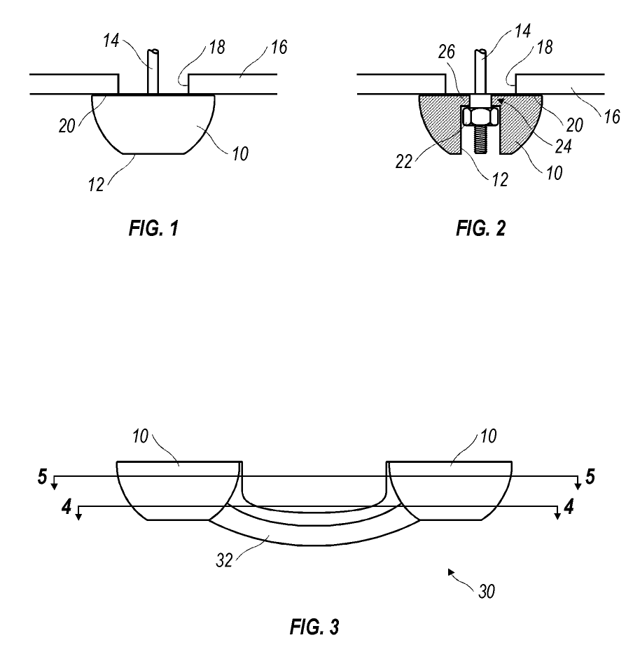

Referring to the figures, wherein like numbers refer to like parts throughout the several views, FIG. 8 shows a pickup truck 60 with a bed cap-cover 65 installed to create an enclosed compartment. Pairs of feet 40 are shown attached to the cover 65, utilizing a housing 10, with a cross-bar 49 suspended therebetween. FIG. 1 shows a side elevation of a housing 10 having an entry 12 to a nut retainer (not shown). The housing 10 holds a receiving nut 22 (as shown in FIG. 2) for a bolt 14 used to connect objects against one side of a supporting structure 16 that includes an opening 18 through which the bolt 14 passes to engage the receiving nut 22. Rotation of the bolt 14 or the receiving nut 22 draws the housing edge 20 to abut the other side of the supporting structure 16.

FIG. 2 clarifies the internal structure of a housing 10 according to the present invention by providing a cross sectional view to show the entry 12 having a receiving nut 22 inserted into a nut retainer 24 therein comprising projections 26 that apply pressure to the side of the receiving nut 22 to hold it inside the nut retainer 24. As illustrated, the bolt 14 passes through the opening 18 to engage the receiving nut 22. The length of the bolt 14 is such that an object becomes securely attached to the supporting structure 16 before the bolt 14 enters the housing 10 far enough for the tip of the bolt 14 to extend outwardly of the entry 12. The positioning of the tip of the bolt 14 inside the entry 12 is a safety consideration to reduce the likelihood of injury to a person who inadvertently strikes the housing 10.

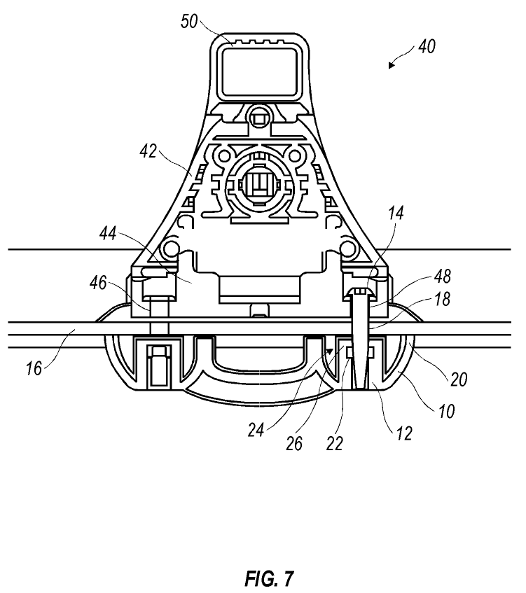

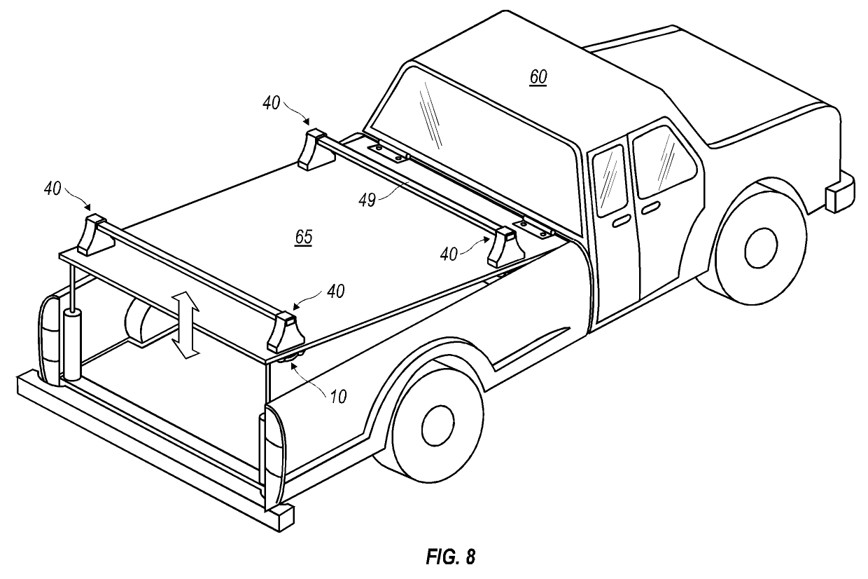

FIGS. 3-6 provide illustration of a nut-retaining bracket 30 suitable for securing a foot support base 44 (shown in FIG. 7) for a load carrier to a supporting structure 16 of a metal plate used in the formation of the roof, or cab or cap of a transporting vehicle. The nut-retaining bracket 30 includes a pair of housings 10, also referred to herein as first and second housings, joined together by a bar or handle 32.

The use of a pair of housings 10 ensures twist-free securement of a foot support base, bolted through opposing openings formed in the supporting structure 16. The need to secure the foot support base in a twist-free condition will be appreciated by considering that it must retain a prescribed orientation to facilitate attachment of a load carrier using several supporting feet connected to foot support bases.

Since it is important to use more than one bolt to prevent rotation or twisting motion, the foot support base 44 has an elongate structure that has guide holes 46, 48 at opposing ends. The distance between the guide hole centers is the same as the distance between the centers of the openings 18 in the supporting structure 16 and the distance of separation of receiving nuts 22 held in nut retainers 24 according to the present invention. Alignment of the guide holes 46, 48, openings 18 and receiving nuts 22 allows insertion of bolts 14 through the elongate base 44 placed against the outer surface of the supporting structure 16, i.e. the roof of the vehicle. The bolts 14 pass through the openings 18 in the vehicle roof to engage nuts 22 in each of the nut retainers 24, inside the housings 10 placed adjacent to the inner surface of the vehicle roof. Rotation of the bolts 14 draws the nuts 22 and housing edges 20 into contact with the inner surface of the vehicle roof. Application of sufficient rotational force produces a tight connection of the foot support base 44 to the supporting structure 16 of the vehicle roof.

FIG. 4, shows a cross section of a nut-retaining bracket 30 according to the present invention taken through line 4-4 of FIG. 3. This view shows retaining nuts 22 located in the entry 12 that leads to the nut retainer 24 in each of the housings 10 joined together by the bar or handle 32.

FIG. 5, shows a cross section of a nut-retaining bracket 30 according to the present invention taken through line 5-5 of FIG. 3. This view shows retaining nuts 22 held by projections 26 of the nut retainer 24 in each of the housings 10 joined together by the bar or handle 32.

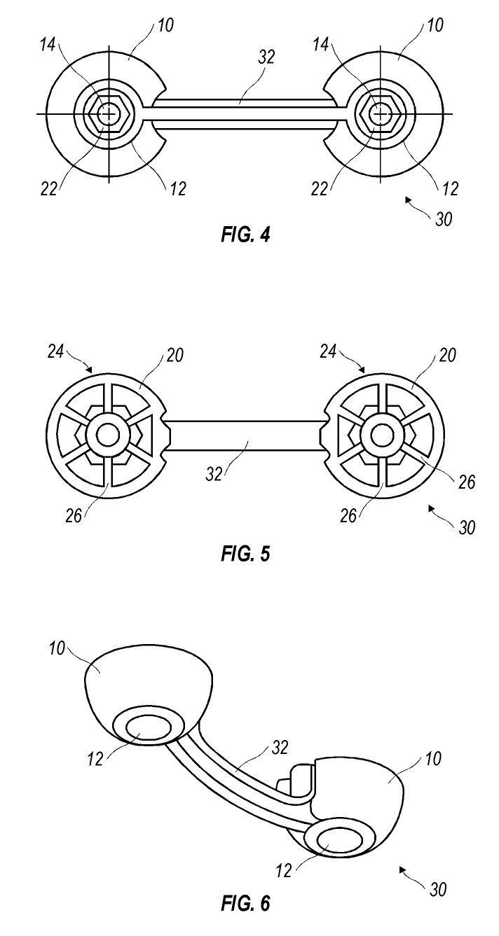

FIG. 6, is a perspective view of a nut-retaining bracket 30 showing the rounded profiles of the housings 10 that have a shape resembling a bowl or inverted dome to reduce potential for passenger injury. A handle 32 joins the housings 10 together and an entry 12 in each housing provides access to receiving nuts 22.

FIG. 7 is a cross sectional view illustrating an assembly 40 for mounting a load carrier on a supporting surface 16 such as the roof of a transporting vehicle. The mounting assembly 40 includes a supporting foot 42 coupled to a foot support base 44 secured to the supporting structure 16 of the vehicle roof using bolts 14 passing through openings 18 in the supporting structure 16 to engage receiving nuts 22 held in nut retainers 24 of a nut-retaining bracket 30 according to the present invention.

As indicated previously, it is important to couple the supporting foot 42 to a foot support base 44 secured by a plurality of bolts 14 to prevent rotation or twisting motion that could cause misalignment of the assembly 40 with the load carrier it supports. A desirable embodiment of an assembly 40 according to the present invention requires that the foot support base 44 have an elongate structure that has guide holes 46, 48 at opposing ends. The distance between the centers of the guide holes 46, 48 is the same as the distance between the centers of openings 18 in the supporting structure 16 and the distance of separation of receiving nuts 22 held in nut retainers 24 according to the present invention. Alignment of the guide holes 46, 48, openings 18 and receiving nuts 22 allows insertion of bolts 14 through the elongate foot support base 44 placed against the outer surface of the supporting structure 16. The bolts 14 engage nuts 22 in each of the nut retainers 24 placed adjacent to the inner surface of the supporting structure 16. Rotation of the bolts 14 draws the nuts 22 and nut retainers 24 towards the inner surface of the supporting structure 16. Application of sufficient rotational force causes contact of the edges of the housings 20 with the inside of the supporting structure 16 to produce a tight connection of the foot support base 44 to the supporting structure 16.

Following coupling of the supporting foot 42 to the foot supporting base 44 secured to the supporting structure 16, such as the roof of a pick up truck, an end portion of a strut 50 inserted into the supporting foot 42 provides connection for one of a plurality of struts that comprise the load carrier. Completion of the connection of a load carrier to the roof of the truck requires other assemblies 40, suitably distributed over the supporting structure 16 of the roof of the truck.

When fully installed, the nut-retaining bracket 30 according to the present invention provides a roof mounted handle 32 that may be grasped to steady a passenger or may function as a rod or bridge for securing other cargo, e.g. straps or hooks or coat hangers and the like to the vehicle roof inside the cab.

A nut retainer incorporated into a nut-retaining bracket and components thereof have been described herein. These and other variations, which will be appreciated by those skilled in the art, are within the intended scope of this invention as claimed below. As previously stated, detailed embodiments of the present invention are disclosed herein; however, it is to be understood that the disclosed embodiments are merely exemplary of the invention that may be embodied in various forms.

### INDUSTRIAL APPLICABILITY

The present invention finds applicability in the sports equipment transportation industries.

What is claimed and desired to be secured by Letters Patent is as follows:

1. An article for retaining nuts used for secure attachment of an object to a supporting structure, the article comprising:
at least one housing including at least a nut retainer for a nut used to secure a bolt passing through the supporting structure for attachment of the object to the supporting structure.

2. The article according to claim 1, wherein the at least one housing has a recess containing the at least a nut retainer.

3. The article according to claim 2, wherein the bolt has a tip portion engaging the nut such that the tip portion remains inside the recess following attachment of the object to the supporting structure.

4. The article according to claim 1, wherein the at least a nut retainer includes a plurality of projections for gripping retention of the nut in the at least a nut retainer.

5. The article according to claim 4, wherein the at least one housing comprises at least a first housing and at least a second housing, the at least a first housing including a first nut retainer for a nut used to secure at least a first bolt passing through the supporting structure for attachment of the object to the supporting structure, the at least a second housing including a second nut retainer for a nut used to secure at least a second bolt passing through the supporting structure for attachment of the object to the supporting structure.

6. The article according to claim 5, further comprising a connector extending between the at least a first housing and the at least a second housing.

7. An article for retaining nuts used for secure attachment of an object to a supporting structure, the article comprising:
a connector extending between at least a first housing and at least a second housing, the at least a first housing including a first nut retainer for a nut used to secure at least a first bolt passing through the supporting structure for attachment of the object to the supporting structure, the at least a second housing including a second nut retainer for a nut used to secure at least a second bolt passing through the supporting structure for attachment of the object to the supporting structure.

8. The article according to claim 7, wherein the connector is a handle having an arcuate profile.

9. The article according to claim 7, wherein the at least a first housing has a first recess containing the first nut retainer and the at least a second housing has a second recess containing the second nut retainer.

10. The article according to claim 9, wherein the at least a first bolt has a tip portion engaging the nut such that the tip portion remains inside the first recess and the at least a second bolt remains inside the second recess following attachment of the object to the supporting structure.

11. The article according to claim 7, wherein each of the at least a first nut retainer and at least a second nut retainer includes a plurality of projections for gripping retention of nuts retained therein.

12. The article according to claim 7, wherein the supporting structure has an outer surface and an inner surface.

13. The article according to claim 12, wherein the object lies adjacent to the outer surface and the article abuts the inner surface of the supporting structure.

14. The article according to claim 13, wherein the supporting structure further includes a plurality of openings having a separation allowing the at least a first bolt and at least a second bolt to pass through the supporting structure to engage nuts in each of the first nut retainer and the second nut retainer placed adjacent to the inner surface of the supporting structure.

15. An article for retaining nuts used for secure attachment of an object to a supporting structure, the article comprising:
a connector extending between at least a first housing having a first recess and at least a second housing having a second recess, the at least a first housing having a first nut retainer including a plurality of projections for gripping retention of a nut used to secure at least a first bolt passing through the supporting structure for attachment of the object to the supporting structure, the at least a second housing having a second nut retainer including a plurality of projections for gripping retention of a nut used to secure at least a second bolt passing through the supporting structure for attachment of the object to the supporting structure, wherein the at least a first bolt has a first tip portion engaging the nut such that the first tip portion remains inside the first recess and the at least a second bolt has a second tip portion engaging the nut such that the second tip portion remains inside the second recess following attachment of the object to the supporting structure which supporting structure has an outer surface and an inner surface such that the object lies adjacent to the outer surface and the article abuts the inner surface of the supporting structure.

16. An assembly for mounting a load carrier on a supporting structure, the assembly comprising:
a supporting foot coupled to a foot support base abutting the supporting structure that has an inner surface and an outer surface against which the foot support base is secured using at least a first bolt passing through a first opening in the supporting structure to engage at least one receiving nut held in at least a first nut retainer of a nut-retaining bracket that includes at least a first housing in contact with the inside of the supporting structure.

17. The assembly according to claim 16, wherein the nut-retaining bracket includes a handle between the at least a first housing and at least a second housing, the at least a first housing containing the at least a first nut retainer and the at least a second housing containing at least a second nut retainer.

18. The assembly according to claim 16, wherein the supporting foot provides connection for an end portion of a strut included as one of a plurality of struts that comprise the load carrier.

19. A process for secure attachment of an object to a supporting structure using an article for retaining nuts comprising:
providing the supporting structure having an outer side and an inner side and further having at least one opening therethrough;
positioning the object on the outer side of the supporting structure;
placing the article, having at least one housing, adjacent to the inner side, the at least one housing including at least a nut retainer for a nut;
using a bolt passing through the opening in suitable fashion to engage the object on the outer side of the supporting structure and the nut in the at least a nut retainer; and
initiating relative rotation between the bolt and the nut drawing the nut retainer towards the inner side until the at least one housing makes contact with the inner side sufficient for secure attachment of the object to the supporting structure.
